(19) United States
(12) Patent Application Publication
(10) Pub. No.: US 2013/0112599 A1
(43) Pub. Date: May 9, 2013

(54) APPARATUS FOR SEPARATING TABLETS

(71) Applicants: Jose Cristobal, Madrid (ES); Ignacio Niño, Madrid (ES)

(72) Inventors: Jose Cristobal, Madrid (ES); Ignacio Niño, Madrid (ES)

(21) Appl. No.: 13/574,178

(22) PCT Filed: Jan. 18, 2011
(86) PCT No.: PCT/EP2011/050576

§ 371 Date: Oct. 5, 2012

(30) Foreign Application Priority Data
Jan. 19, 2010 (GB) 1000769.8

(51) Int. Cl. B07B 1/28

(52) U.S. Cl. CPC B07B 1/28
USPC 209/235

(57) ABSTRACT

An apparatus to separate broken tablets comprising: a sieve plate having at least one perforation; a cover plate which is distanced from the sieve plate by an amount suitable to permit only broken tablets below a certain predetermined size to pass through the at least one perforation; and a vibrating device which vibrates the sieve plate.

The object of the invention is to provide an apparatus which separates broken and unbroken tablets.

Tablets can be broken during the production process and broken tablets can cause the blockages within a packaging line. Previously tablets which were broken and therefore smaller were removed by offline visual inspection. The human visual inspection process is not carried out during the packaging process. Rather the tablets are removed from the packaging line and sorted manually and then whole tablets returned to the packaging line. An automatic apparatus which separates broken and unbroken tablets from a packaging line to reduce cost and improve efficiency is desirable.

U.S. Pat. No. 4,172,528 which describes an apparatus that works using a horizontally circular perforated plate having perforations for passing smaller tablets through. This apparatus has a vibrator which vibrates the perforated plate. The tablets are fed onto the circular perforated plate whereby the smaller tablets fall through the perforations and the larger tablets do not fall through the perforations and remain within the apparatus until such a time when all the smaller tablets are deemed to be removed. Then the larger tablets are blown towards the periphery of the circular plate and guided through a tunnel towards a container. After the tablets have been selected they are then placed back within the packaging line.

There are several disadvantages to the prior art. Firstly the apparatus does not function within the tablet packaging line. Secondly the apparatus only selects tablets according to the tablet diameter. Thirdly the apparatus only works with round tablets. Fourthly the apparatus only discharges tablets at intervals once the smaller tablets have been removed from a certain batch, therefore the apparatus cannot be continuously filled with tablets.

The current invention provides an apparatus for separating broken and unbroken tablets which can be placed within the packaging line. The apparatus comprises a sieve plate which has at least one perforation whereby a cover plate is placed at a predetermined height above said sieve plate.

The tablets then pass over the sieve plate, between the sieve plate and the cover plate. The broken tablets pass through the at least one perforation whilst the unbroken tablets pass fully over the sieve plate. The distance between the cover plate and the sieve plate is predetermined in order to allow only broken tablets to pass through the at least one perforation.

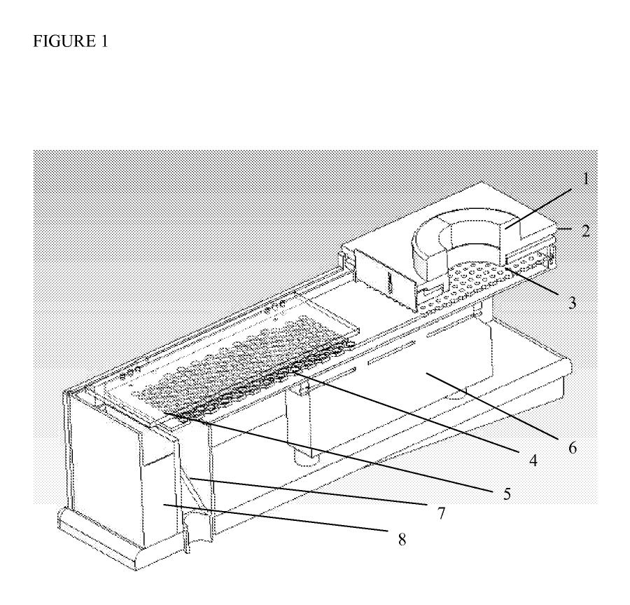

FIG. 1 shows a cross-section of an apparatus for separating tablets. It comprises a feeder mouth (1) integral with a cover plate (2), two sets of perforations (3) and (4) of increasing size, the latter being covered by a second cover plate (5), a vibrating device (6), a chute to remove broken tablets (7) and a hopper to collect unbroken tablets (8). The apparatus is shown inclined to the horizontal.

The present invention is an apparatus which comprises:
a sieve plate having at least one perforation;
a cover plate which is distanced from the sieve plate by an amount suitable to permit only broken tablets below a certain predetermined size to pass through the at least one perforation;
and a vibrating device which vibrates the sieve plate.

Broken tablets are defined as being less than 90%, less than 80%, less than 75% or less than 70% complete by weight. In general a broken tablet is less than 75% complete.

The sieve plate has at least one perforation to allow the broken tablets to pass through. The cover plate prevents tablets from falling off the sieve plate. The cover plate is distanced from the sieve plate by an amount suitable to permit only broken tablets to pass through the at least one perforation of the sieve plate. The cover plate is placed at a height above the sieve plate sufficient to prevent unbroken tablets falling through the at least one perforation. Unbroken tablets are thus unable to adopt an angle to the horizontal sufficient to fall through the at least one perforation. The vibrating device is necessary to facilitate movement of the tablets across the sieve plate.

The cover plate may be continuous or discontinuous providing that it covers the at least one perforation.

The apparatus of the present invention has at least one perforation which may be circular. The circular perforations of the present invention may be used with elongated tablets. The elongated tablets used in the present invention generally have a ratio of width to length of at least 1:2.5. The circular perforations generally have a diameter of from the width of the tablet to twice the width of the tablet.

In one embodiment the at least one perforation of the sieve plate is smaller than the tablet when the tablet is not broken. This feature prevents unbroken tablets passing through the at least one perforation with the broken tablets.

The sieve plate generally contains more than 50, more than 100, more than 200 or more than 400 perforations. In one embodiment the perforations are of two or more different sizes such that broken tablets of different sizes are removed. This aids the efficiency of the separation process. In general, where there are perforations of two different sizes these remove broken tablets up to 25% complete and up to 50% complete respectively. In one embodiment the sieve plate contains an array of smaller perforations and then an array of larger perforations. The two arrays may be separated by a portion which contains no perforations.

In one embodiment the sieve plate is placed at an incline to the horizontal. In another embodiment the sieve plate is horizontal. When the sieve plate is placed at an incline to the horizontal, gravity encourages the tablets to pass over the sieve plate. When the sieve plate is placed horizontal the vibrating device and the weight of tablets encourage the tablets to pass over the sieve plate.

Preferably the vibrating device vibrates perpendicularly to the sieve plate. This allows the most efficient use of the vibrating device as this encourages the tablets to pass over the sieve plate. The vibrating device may vibrate the sieve plate in parallel, or have a parallel component, although this is not as efficient as perpendicular vibrations.

The apparatus may additionally comprise a feeding mouth for feeding broken and unbroken tablets into the apparatus.

The apparatus may also comprise a container for collecting broken tablets which have passed through the at least one perforation of the sieve plate. This allows the broken tablets to be discarded. There may also be a hopper to collect unbroken tablets.

The present invention also provides a packaging line which comprises the tablet separating apparatus of the present invention.

The present invention also provides a method of separating tablets comprising the steps of:
feeding the broken and unbroken tablets into the apparatus of the invention;
allowing the broken and unbroken tablets to pass over the sieve plate;
collecting broken tablets that have passed through the at least one perforation.

### EXAMPLE 1

TRIAL (5080 correct tablets + 150 broken tablets)

| Altura | Diámetro | Velocidad | 1 | | 2 | | 3 | |
|---|---|---|---|---|---|---|---|---|
| Placa | Agujero | Vibración | Y₁ | Y₂ | Y₁ | Y₂ | Y₁ | Y₂ |
| 11.1 | 11.5 | 7 | 133 | 125 | | | | |
| 9.5 | 12.3 | 7 | 139 | 0 | 145 | 0 | 145 | 1 |
| 11.1 | 11.5 | 9 | 131 | 34 | | | | |
| 9.5 | 12.3 | 9 | 126 | 0 | 128 | 0 | 132 | 0 |
| 10.9 | 11.5 | 9 | 131 | 4 | 134 | 6 | 138 | 5 |
| 9 | 12.3 | 7 | 129 | 0 | 126 | 0 | 130 | 0 |
| 10.9 | 11.5 | 7 | 130 | 0 | 135 | 13 | 134 | 4 |
| 9 | 12.3 | 9 | 132 | 1 | 130 | 0 | 125 | 0 |

Y1: Broken tablets
Y2: False negatives unbroken tablets which have been rejected

The apparatus was tested using the 3 variables. Firstly the distance between the cover plate and the sieve plate (mm). Secondly the perforation diameter (mm), and thirdly the vibration level. Each trial consisted of 5080 tablets which included 150 broken tablets. The broken tablets were 25%, 25-50% and 50% broken. The batch of tablets was passed through the apparatus 3 times using the factor combination. False negatives were also noted (the number of unbroken tablets which passed through the perforations). The same batch of tablets was used in each run. Up to three runs were carried out for each set of conditions.

1. An apparatus to separate broken tablets comprising:
a sieve plate having at least one perforation;
a cover plate which is distanced from the sieve plate by an amount suitable to permit only broken tablets below a certain predetermined size to pass through the at least one perforation;
and a vibrating device which vibrates the sieve plate.

2. An apparatus according to claim 1 wherein the at least one perforation is circular.

3. An apparatus according to claim 2 wherein said tablets are elongated.

4. An apparatus according to claim 3 wherein the tablets have a ratio of width to length of at least 1:2.5.

5. An apparatus according to claim 4 wherein the diameter of the perforation is from the width of the tablet to twice the width of the tablet.

6. An apparatus according to claim 1 wherein the at least one perforation is smaller than the tablet when the tablet is not broken.

7. An apparatus according to claim 1 wherein the sieve plate is placed at an incline to the horizontal or horizontal.

8. An apparatus according to claim 1 wherein the vibrating device vibrates perpendicularly to the sieve plate.

9. An apparatus of claim 5 which comprises perforations of two different sizes.

10. An apparatus according to claim 1 further comprising a feeding opening for feeding broken and unbroken tables into the apparatus.

11. An apparatus according to claim 1 further comprising a containing device for collecting broken tablets which have passed through the at least one perforation of the sieve plate.

12. A line for packaging tables comprising the apparatus according to claim 1.

13. A method of separating tablets comprising the steps:
feeding the broken and unbroken tablets into the apparatus according to claim 1;
allowing the broken and unbroken tablets to pass over the sieve plate;
collecting broken tablets that have passed through the at least one perforation; and
collecting unbroken tablets that have passed over the sieve plate.
